(19) United States
(12) Patent Application Publication
(10) Pub. No.: US 2015/0117048 A1
(43) Pub. Date: Apr. 30, 2015

(54) Vehicle Auxiliary Light Assembly

(71) Applicant: Yao Hung Huang, Taiwan (CN)

(72) Inventor: Yao Hung Huang, Taiwan (CN)

(21) Appl. No.: 14/069,320

(22) Filed: Oct. 31, 2013

(51) Int. Cl. F21S 8/10; B60Q 1/50; B60Q 1/44; B60Q 1/26; B60Q 1/38

(52) U.S. Cl. CPC F21S 48/212; B60Q 1/2696; B60Q 1/2607; B60Q 1/38; B60Q 1/44; B60Q 1/50
USPC 362/541

(57) ABSTRACT

A vehicle auxiliary light assembly (VALA) that is comprised of a first LED section that is vertically attached adjacent the right side of a vehicle's rear window and a similar second LED section that is vertically attached adjacent the left side of a vehicle's rear window. Each LED section is controlled by a vehicle's rear lights control terminal that produces a white light when a reverse signal is applied, a yellow light when the right or left turn is applied, and a red light when a brake signal is applied when a selected vehicle light is activated, a corresponding LED illuminates in synchrony with the selected vehicle light.

### TECHNICAL FIELD

The invention generally pertains to vehicle light assemblies, and more particularly to a vehicle auxiliary light assembly (VALA). The VALA is comprised of a first LED light assembly attached adjacent to the left side of a vehicle's rear window and a second LED light assembly attached adjacent to the right side of the vehicle's rear window. The VALA LEDs illuminate in synchrony and in the colors that correspond to a reverse signal, a right and left turn signal, and a brake signal.

### BACKGROUND ART

Conventional vehicle rear-light assemblies typically utilize LEDs or halogen bulbs to illuminate a reverse light, a right and left turn light, a tail light signal and a brake light. The halogen light bulbs and LEDs are selected to provide a particular color such as a white light for a reverse signal, a yellow light for right and left turn signals, and a red light for a brake light.

In tail-light assemblies that use halogen bulbs, three colored lenses or lights are required to produce the white light, yellow light and red light. Alternatively, most current vehicle models use colored LEDs which have a longer useful life, conserve energy and are friendly to the environment. Also, by using colored LEDs, the necessity to have colored lenses is not required because the individual LEDs provide the required colors, namely white, yellow and red.

A search of the prior art did not disclose any literature or patents that read directly on the claims of the instant invention. However, the following U.S. patents are considered related:

| PATENT NO. | INVENTOR | ISSUED |
|---|---|---|
| 6,533,445 | Rogers | 18 Mar. 2003 |
| 5,896,084 | Weiss et al | 20 Apr. 1999 |
| 5,567,036 | Theobald et al | 22 Oct. 1996 |

The U.S. Pat. No. 6,533,445 discloses a unitary multiple light assembly for motor vehicle trailers. The assembly uses different arrays of LEDs to illuminate a side marker light, a rear tail or brake light, and a license plate light. A license plate attaching bracket holds a license plate in a location in which individual LEDs in a light fixture can shine directly on the license plate.

The U.S. Pat. No. 5,896,084 discloses a tail light assembly for a motor vehicle. The assembly includes a rear light, a brake light, and a turn signal light, wherein the rear light, the brake light, and the turn signal lights are comprised of LEDs. The assembly also includes a control device for operating the LEDs at a constant current for a given voltage range.

The U.S. Pat. No. 5,567,0346 discloses a side marker lamp that is used for truck/trailer combinations. The lamp utilizes LEDs that are mounted to a plurality of circuit boards. The circuit boards are mounted at predetermined angles relative to each other for directing light in at least three directions. A lens is placed in front of the LEDs and includes a series of prism optics for spreading the light emitted from the LEDs into an arc of up to 180 degrees.

For background purposes and indicative of the art to which the invention relates, reference may be made to the following remaining patents found in the patent search.

| PATENT NO. | INVENTOR | ISSUED |
|---|---|---|
| 6,095,663 | Pond et al | 1 Aug. 2000 |
| 5,150,959 | Paffrath et al | 29 Sep. 1992 |
| 1,887,087 | Prizner | 8 Nov. 1932 |
| 1,567,193 | Ritz-Woller | 29 Dec. 192 |
| 1,526,868 | Petrovich | 17 Feb. 1925 |
| 1,513,300 | Vose | 28 Oct. 1924 |

### DISCLOSURE OF THE INVENTION

The vehicle auxiliary light assembly (VALA) is designed to utilize a pair of LED light assemblies to augment the rear facing lights that are required when operating a vehicle. For purposes of this disclosure, a vehicle is defined as an automobile, a truck, an SUV, a trailer, a trailer truck, a boat or various military vehicles. The required lights include a reverse light, a right and left turn-signal light, and a brake light.

The VALA is designed to increase the visibility of the rear lights of a vehicle that is in front of a following vehicle to aid in reducing incidents of rear end collisions. The LED light assemblies are attached adjacent the right and left side edges of the vehicle's rear window. This placement minimizes visual blockage when using the vehicle's rear view mirror.

The VALA is designed to function in combination with a vehicle's a rear window, a rear lights control terminal that is connected to a reverse light, a brake light, a right and left turn light, and circuit ground. In its basic design configuration the VALA is comprised of:

A) A first LED light assembly that is attached adjacent the right side edge of the vehicle's rear window,

B) A second LED light assembly that is attached adjacent the left side edge of the vehicle's rear window and that is connected in parallel with said first LED light assembly, and

C) Means for attaching the first and the second LED light assemblies to the vehicle's rear window.

The LED light assembly is comprised of a first section having a plurality of LEDs that are connected in a series/parallel configuration. The first section also has an upper end and a lower end. The upper end is attached to a selectable light source located on the rear lights control terminal, and the lower end is connected to circuit ground. When a vehicle light is activated by a vehicle driver, a corresponding LED illuminates in synchrony with the selected vehicle light.

The LED light assembly is further comprised of a second section having a plurality of LEDs that are connected in a series/parallel configuration. The second section also has an upper end and a lower end, wherein the upper end is attached to a selectable light source located on the rear lights control terminal, and the lower end is connected to circuit ground. When a selected vehicle light is activated by the vehicle driver, a corresponding LED illuminates in synchrony with the selected vehicle light.

In view of the above disclosure the primary object of the invention is to produce a VALA having a first LED light assembly that is attached adjacent the right side of the vehicle's rear window and a second LED light assembly that is attached adjacent the left side of the vehicle's rear window. The illumination of the two LED light assemblies is controlled by a vehicle's electrical circuit that illuminates a white light when the vehicle produces a reverse signal, a yellow light when a right and left turn signal is produced and a red light when a brake light signal is produced.

In addition to the primary object of the invention it is also an object of the invention to produce a VALA that:
is protected from inclement weather,
aids in reducing incidents of rear-end collisions,
adds to the aesthetics of the vehicle,
is easy to install and maintain,
can potentially have an effect on insurance costs,
can be used on many types of vehicles,
can be produced as an OEM product or as an after-market product, and
is cost effective from both a manufacturer's and consumer's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a block diagram of the vehicle auxiliary light assembly.

FIG. 2 is a schematic diagram of a first LED light assembly.

FIG. 3 is a schematic diagram of a second LED light assembly.

FIG. 4 is a schematic design of a third LED light assembly.

FIG. 5 is an elevational view of a vehicle's rear end having a LED light assembly attached adjacent to each side of the vehicle's rear window.

FIG. 6 is a cross-sectional view of a window attachment means that utilizes a double-sided tape.

FIG. 7 is an elevational front view of a double-sided tape having an opening that allows a plurality of LEDs to be exposed.

FIG. 8 is a cross-sectional view of an LED light assembly that is laminated between the outer surface and the inner surface of the rear window.

FIG. 9 is a cross-sectional view showing the relative position of a conducting layer, a reflecting layer and a printed layer that interfaces with the rear window.

### BEST MODE FOR CARRYING OUT THE INVENTION

The best mode for carrying out the invention is presented in terms that disclose a preferred embodiment of a vehicle auxiliary light assembly (VALA). The VALA utilizes the vehicle's electrical light circuit to operate a first and a second LED light assembly that provide additional rear-facing lights to more safety operate the vehicle.

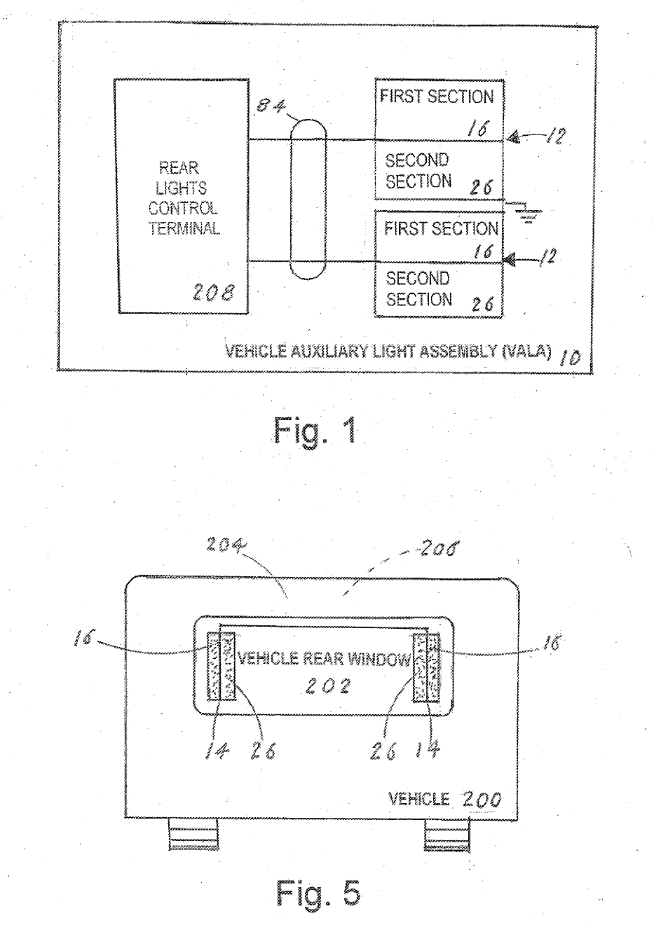

The preferred embodiment of the VALA 10, as shown in FIGS. 1-9, is comprised of the following major elements: a first LED light assembly 14, a second LED light assembly 38, a third LED light assembly 60 and a window attachment means 76.

The inventive elements function in combination with a vehicle 200 having a rear window 202 having an outer surface 204 and an inner surface 206, and a rear lights control terminal 208 that is connected to a reverse light 210, a brake light 212, a right turn light 216, a left turn light 218 and circuit ground 220. A block diagram of the VALA 10 is shown in FIG. 1.

The VALA 10 can be designed to illuminate various LEDs that correspond with the activation of a particular vehicle rear light. Three examples of the VALA 10 are disclosed in the following paragraphs.

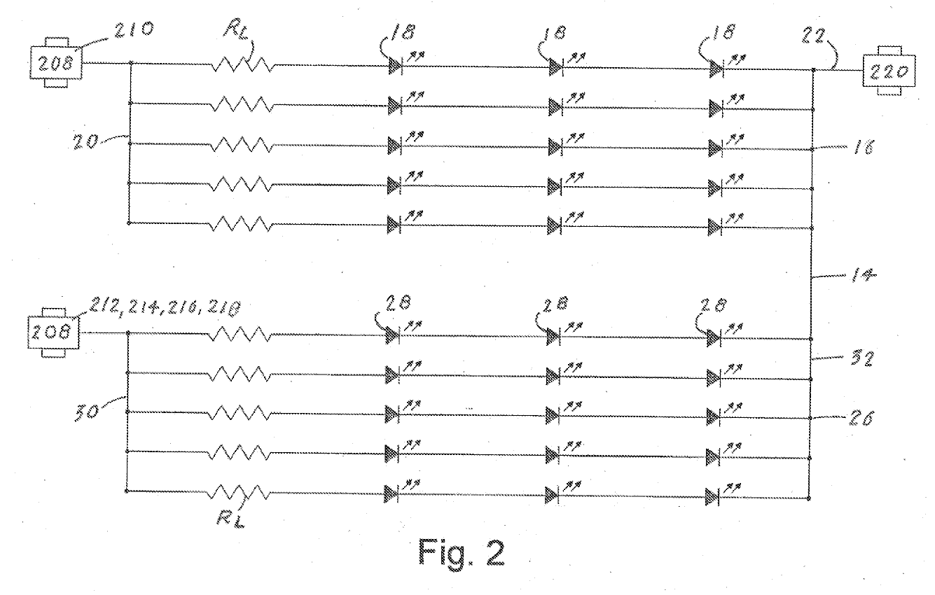

The first LED light assembly 14, as shown in FIG. 2, is comprised of a first section 16 and a second section 26. The first section 16 has a plurality of white LEDs 18 that are connected in a series/parallel configuration, an upper end 20 that is connected via a current limiting resistor R_{L} to the reverse light 210 located on the rear lights control terminal 208, and a lower end 22 that is connected to circuit ground 220.

The second section 26, as also shown in FIG. 2, has a plurality of red LEDs 28 that are connected in a series/parallel configuration; an upper end 30 that is connected to the brake light 212, and to the right and left turn lights 216,218, which are located on the rear lights control terminal 208; and a lower end 32 connected to circuit ground 220. The second section 26 is connected in parallel with the first section 16. When a reverse signal is produced the standard vehicle white lights illuminate in synchrony with the white LEDs 18 located on the first section 16 of the first LED light assembly 14, the standard red lights located on the vehicle 200 also illuminate in synchrony with the red LEDs 28 located on the second section 26 of the first LED light assembly 14.

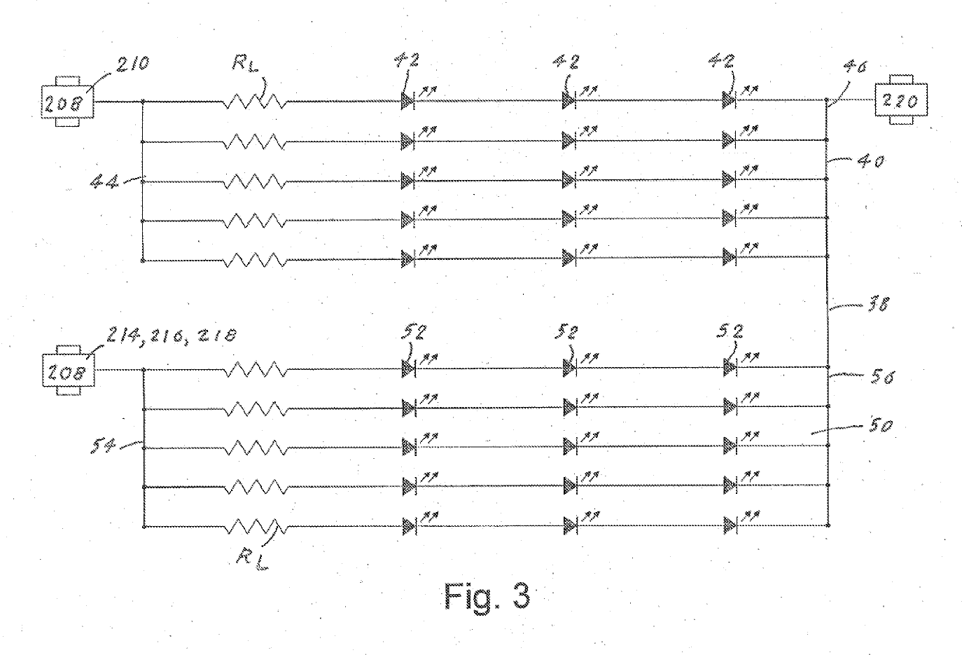

The second LED light assembly 38, as shown in FIG. 3, is comprised of a first section 40 and a second section 50. The first section 40 has a plurality of white LEDs 42, an upper end 44 that is connected to the reverse light 210 via a current limiting resistor R1, to the rear lights control terminal 208, and a lower end 46 that is connected to circuit ground 220.

The second section 50 has a plurality of yellow LEDs 52, that are connected in a series/parallel configuration, an upper end 54 connected to the right and left turn lights 216,218 located on the rear lights control terminal 208, and a lower end 56 connected to circuit ground 220. The second section 50 is connected in parallel with the first section 40. When a right or left turn signal 216,218 is produced the standard vehicle yellow lights illuminate in synchrony with the yellow LEDs 52 located on the second section 50 of the second LED light assembly 38.

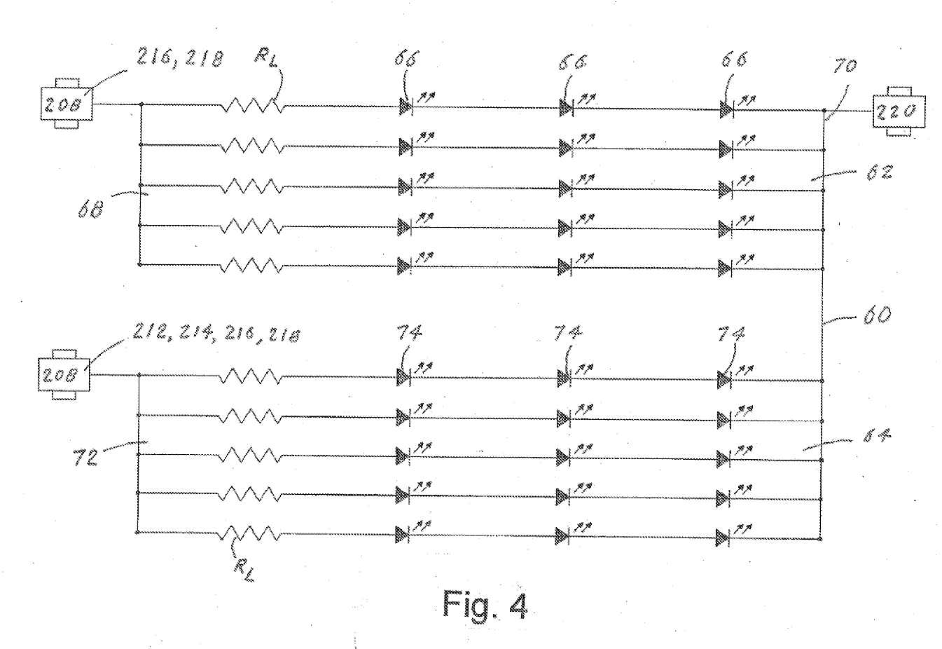

The third LED light assembly 60, as shown in FIG. 4, is comprised of a first section 62 and a second section 64. The first section 62 has a plurality of yellow LEDs 66, an upper end 68 that is connected to the right and left turn lights 216,218 via a current limiting resistor R_{L} to the rear lights control terminal 208, and a lower end 70 that is connected to circuit ground 220.

The second section 64 has a plurality of red LEDs 74 that are connected in a series/parallel configuration, an upper end 72 that is connected to the brake light 212, and to the right and left turn lights 216,218, and a lower end 70 that is connected to circuit ground 220. The second section 64 is connected in parallel with the first section 62. When a brake light 212 signal is produced the standard vehicle red lights illuminate in synchrony with the red LEDs 74 located on the second section 64 of the third LED light assembly 60.

Each of the LED light assemblies 12, as shown in FIGS. 2, 0.3 and 4, include a first section 16 and a second section 26. The first section 16 is comprised of fifteen LEDs stacked in five rows with each row having three LEDs in series with a current limiting resistor R_{L} that is connected to the respective light signal located on the vehicle's rear lights control terminal 208. The second section 26 is also comprised of fifteen LEDs stacked in five rows with each row having three LEDs in series with a current limiting resistor connected to the respective light signal on the vehicle's rear lights control terminal. Each LED light assembly is comprised of a total of thirty LEDs.

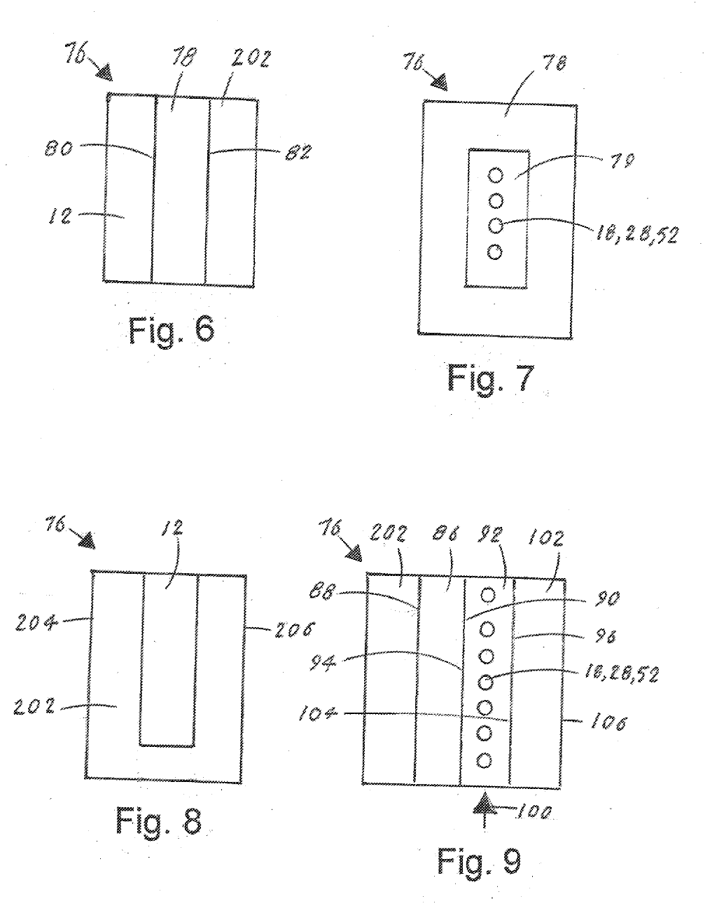

The window attachment means 76, as shown in FIG. 6, can be comprised of a clear double-sided tape 78 having a first side 80 and a second side 82. The first side 80 is attached to the LED side of the LED light assembly 12 and the second side 82 is attached to the rear window 202. The double-sided tape 78, as shown in FIG. 7, can also be designed to include an opening 79 to allow the plurality of LEDs to be exposed. The window attachment means 76 can also be accomplished by having the LED light assembly laminated between the outer surface 204 and the inner surface 206 of the rear window 202, as shown in FIG. 8.

Alternatively, as shown in FIG. 9, the window attachment means 76 can be comprised of a conducting layer 86, a reflecting layer 92 and a printed layer 102. The conducting layer 86 has a first side 88 and a second side 90, wherein the first side 88 interfaces with the vehicle's rear window 202.

The reflecting layer 92 has a first side 94 and a second side 96, wherein the first side 94 interfaces with the second side 90 of the conducting layer 86. The reflecting layer 92 has attached a plurality of LEDs 18,28,52 that are connected to a power source 100 via the reflecting layer 92.

The printed layer 102 has a first side 104 and a second side 106, wherein the first side 104 interfaces with the second side 96 of the reflecting layer 92. When power from the power source 100 is applied the illumination from the LEDs, is reflected into the exterior environment.

As shown in FIG. 5, a LED light assembly 12 is attached adjacent to each side of the vehicle's rear window 202. The LED light assembly 12 is attached to the rear lights terminal 208 by means of a spliced cable 84, as shown in FIG. 1.

While the invention has been described in detail and pictorially shown in the accompanying drawings it is not to be limited to such details, since many changes and modification may be made to the invention without departing from the spirit and the scope thereof. For example, the quantity of LEDs utilizes for each LED light assembly can range from 20 to 40 LEDs. Hence, it is described to cover any and all modifications and forms which may come within the language and scope of the claims.

1. A vehicle auxiliary light assembly (VALA) that functions in combination with a vehicle's a rear window that includes an outer surface and an inner surface, and a rear lights control terminal that is connected to a vehicle's reverse lights, brake lights, right and left turn lights, and circuit ground, said VALA comprising:
a) a first LED light assembly attached adjacent the right side edge of the vehicle's rear window,
b) a second LED light assembly attached adjacent the left side edge of the vehicle's rear window, and
c) means for attaching said first and said second LED light assemblies to the vehicle's rear window.

2. The VALA as specified in claim 1 wherein said first assembly is further comprised of a first section having a plurality of LEDs that are connected in a series/parallel configuration, wherein said first section having an upper end and a lower end, wherein the upper end is attached to a selectable vehicle light source located on the rear lights control terminal, and the lower end is connected to circuit ground, wherein when a selected vehicle light is activated a corresponding LED illuminates in synchrony with the selected vehicle light.

3. The VALA as specified in claim 2 wherein said first assembly is further comprised of a second section having a plurality of LEDs that are connected in a series/parallel configuration, wherein said second section having an upper end and a lower end, wherein the upper end is attached to a selectable light source located on the rear lights control terminal, and the lower end is connected to circuit ground, wherein said first section is connected in parallel with said second section, wherein when a selected vehicle light is activated, a corresponding LED illuminates in synchrony with the selected vehicle light.

4. The VALA as specified in claim 1 wherein said window attachment means comprises a clear double-sided tape having a first side and a second side, wherein the first side is attached to the LED side of said LED light assembly and the second side is attached to the rear window.

5. The VALA as specified in claim 4 wherein said means for attaching said LED assembly to the vehicle's rear window comprises said LED light assembly being laminated between the outer surface and the inner surface of the rear window.

6. The VALA as specified in claim 5 wherein said plurality of LEDs located on the first section of said first LED light assembly are comprised of white LEDs stacked in rows with each row having three LEDs in series with a current limiting resistor connected to the respective light signal on the vehicle's rear lights control terminal.

7. The VALA as specified in claim 3 wherein said plurality of LEDs located on the second section of said first LEDs light assembly are comprised of red LEDs stacked in rows with each row having three LEDs in series with a current limiting resistor connected to the respective light signal on the vehicle's rear lights control terminal.

8. A vehicle auxiliary light assembly (VALA) that functions in combination with a vehicle's rear window that includes an outer surface and an inner surface, a rear lights control terminal that is connected to a vehicle's reverse lights, brake lights, right and left turn lights, and circuit ground, said VALA comprising:
a) a first LED light assembly attached by a window attachment means adjacent the right side edge of the vehicle's rear window, and
b) an identical LED light assembly attached by the window attachment means adjacent the left side edge of the vehicle's rear window.

9. The VALA as specified in claim 8 wherein said first and second LED light assemblies further comprise:
a) a first section having a plurality of white LEDs connected in a series/parallel configuration, an upper end connected via a current limiting resistor to the reverse lights on the rear lights control terminal, and a lower end connected to circuit ground, wherein when a reverse signal is produced, the vehicle's standard white lights illuminate in synchrony with the plurality of white LEDs, and
b) a second section having a plurality of red LEDs connected in a series/parallel configuration, an upper end connected via a current limiting resistor to the brake lights on the rear lights control terminal, and a lower end connected to circuit ground, wherein said first section is connected in parallel with said second section, wherein when a brake signal is produced, the vehicle's standard red lights illuminate in synchrony with the plurality of red LEDs.

10. The VALA as specified in claim 8 wherein said first and second LED light assemblies further comprise:
a) a first section having a plurality of white LEDs connected in a series/parallel configuration, an upper end connected via a current limiting resistor to the reverse lights on the rear lights control terminal, and a lower end connected to circuit ground, wherein when a reverse signal is produced the vehicle's standard white lights illuminate in synchrony with the plurality of white LEDs, and
b) a second section having a plurality of yellow LEDs connected in a series/parallel configuration, an upper end connected via a current limiting resistor to the right and left turn lights, on the rear lights control terminal and a lower end connected to circuit ground, wherein said first section is connected in parallel with said second section, wherein when a right or left turn signal is produced the vehicle's standard yellow lights illuminate in synchrony with the yellow LEDs.

11. The VALA as specified in claim 8 wherein said first and second LED light assemblies further comprise:
a) a first section having a plurality of yellow LEDs connected in a series/parallel configuration, an upper end connected via a current limiting resistor to the right and left turn lights on the rear lights control terminal, and a lower end connected to circuit ground, and
b) a second section having a plurality of red LEDs connected in a series/parallel configuration, an upper end connected via a current limiting resistor to the brake lights, on the rear lights control terminal and a lower end connected to circuit ground, wherein said first section is connected in parallel with said second section, wherein when a brake light signal is produced the standard vehicle red lights illuminates in synchrony with the red LEDs on said first and second sections.

12. The VALA as specified in claim 8 wherein said window attachment means comprises a clear double-sided tape having a first side and a second side, wherein the first side is attached to the LED side of said first and second sections and the second side is attached to the rear window.

13. The VALA as specified in claim 9 wherein said double-sided tape having an opening that is dimensioned to allow said plurality of LEDs to be exposed.

14. The VALA as specified in claim 8 wherein said means for attaching said LEDs to the vehicle's rear window is accomplished by having said LEDs laminated between the outer surface and the inner surface of the rear window.

15. The VALA as specified in claim 8 wherein means for attaching said LEDs to the vehicle's rear window comprises an integrated structure having:
a) a conducting layer having a first side and a second side, wherein the first side interfaces with the vehicle's rear window,
b) a reflection layer having a first side and a second side, wherein the first side interfaces with the second side of said conducting layer, wherein said reflection layer having attached a plurality of LEDs that are connected to a power source via said reflection layer, and
c) a printed layer having a first side and a second side wherein the first side interfaces with the second side of said reflection layer, wherein when power is applied the illumination from said LEDs, is reflected to the exterior environment.

16. The VALA as specified in claim 8 wherein said plurality of LEDs located on said first and second LED light sections are comprised of:
a) fifteen white LEDs stacked in five rows with each row having three LEDs in series with a current limiting resistor connected to the respective light signal on the vehicle's rear lights control terminal, and
b) fifteen red LEDs stacked in five rows with each row having three LEDs in series with a current limiting resistor connected to the respective light signal on the vehicle's rear lights control terminal.

17. The VALA as specified in claim 8 wherein said plurality of LEDs located on said first and second LED light sections are comprised of:
a) fifteen white LEDs stacked in five rows with each row having three LEDs in series with a current limiting resistor connected to the respective light signal on the vehicle's rear lights terminal, and
b) fifteen yellow LEDs stacked in five rows with each row having three LEDs in series with a current limiting resistor connected to the respective light signal on the vehicle's rear lights control terminal.

18. The VALA as specified in claim 8 wherein said plurality of LEDs located on said first and second LED light sections are comprised of:
a) fifteen yellow LEDs stacked in five rows with each row having three LEDs in series with a current limiting resistor connected to the respective light signal on the vehicle's rear lights control terminal, and
b) fifteen red LEDs stacked in five rows with each row having three LEDs in series with a current limiting resistor connected to the respective light signal on the vehicle's rear lights control terminal.

19. The VALA as specified in claim 16 wherein said first and second LED light sections are each comprised of a total of thirty LEDs.
